(19) United States
(12) Patent Application Publication
(10) Pub. No.: US 2003/0093463 A1
(43) Pub. Date: May 15, 2003

(54) Dynamic distribution and network storage system

(76) Inventor: Eric S. Graf, Chicago, IL (US)

Correspondence Address: Kirk A. Vander Leest, McAndrews, Held & Malloy, Ltd., Suite 3400, 500 West Madison, Chicago, IL, 60661, US

(21) Appl. No.: 09/990,619

(22) Filed: Nov. 13, 2001

(51) Int. Cl. G06F 15/16

(52) U.S. Cl. 709/203; 709/219

(57) ABSTRACT

A method and system for dynamic distribution and network storage of data includes transmitting data to a network and circulating the data within the network in order to store the data. The method also includes determining which data is to be circulated and stored within the network. The data may be divided into packets and modified to indicate that the packets should be circulated within the network in order to store the data.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The disclosed embodiments of the present invention generally relate to distributed client/server model systems, and in particular relate to access and storage of information in distributed client/server systems.

Typically, information is accessed over a network, such as the Internet or a private or local network, for example, using the client/server model. For example, a user on a personal computer with a web browser requests a web page. The web page is stored on a web server, and a request for the web page is sent over the Internet from the web-browsing computer to the web server. Once the web server (the server) receives the request for the web page from the web-browsing computer (the client), the server transmits the desired web page or other information to the client. Thus, the web page is viewable in the user's web browser.

Information or data is sent over a network, such as the Internet, for example, according to a communications protocol or suite of communications protocols, such as Transmission Control Protocol/Internet Protocol (“TCP/IP”), for example. TCP/IP is a suite of communications protocols that allow data to be transmitted and resources to be shared over a network. TCP/IP moves data across a network in packets, which consist of data, header information, and footer information, for example. The header information may reveal the origin and destination of the packet, the size of the packet, the total number of packets in the transmission, the number of the particular packet to which the header is attached, and protocol information, for example. The footer information may indicate the end of the packet data and also may include error correction information, for example.

The IP forwards packets of data across a network, such as the Internet, based on a unique destination address, or IP address, which is typically four bytes in length. IP addresses or numbers are assigned to computers on the Internet by authorized Internet authorities. IP forwards packets of data across a network from node to node in the network using routers.

Routers are hardware that forward packets to the destination address. Routers may include software to determine the route along which to forward a packet. A router may forward a packet based on an algorithm, such as a geographical “clockwise” algorithm or a network traffic analysis algorithm, for example. Typically, a router includes a routing table or database that tracks the packets transmitted by the router and packet route status, for example.

Simple Network Management Protocol (SNMP) or another such management protocol may be used to manage an IP network. SNMP is a part of the TCP/IP communications protocol suite. SNMP facilitates the exchange of network or management information between devices on the network. SNMP works with TCP/IP to monitor traffic in the network and status of packets and routers in the network, for example. SNMP may monitor the network and collect statistics. In the event of network congestion or other problem, SNMP may be used to reallocate network resources or re-route network traffic, for example.

TCP is used to ensure that data packets are transmitted correctly between client and server. TCP may acknowledge transmission or receipt of data. TCP may detect errors in data packets or loss of data during transmission. If an error in a data packet is not correctable or if a data packet is lost, TCP may initiate re-transmission of the data.

Currently, if a client desires a web page, a database, or an application, for example, that is housed on a server, the client transmits a request to the server, and the server then transmits the requested web page, database, or application, for example, to the client. In many cases, a server may be overloaded by requests for information and may slow down, freeze, crash, or otherwise impair operation of the server. For example, if numerous users are attempting to access the same web page on a web server, the web server may not be able to handle all of the requests and may crash or shutdown. Alternatively, the web server may refuse requests due to lack of system resources, and, as a result, the desired data may be unavailable to many clients.

Currently, the speed, capacity, and accessibility of a server limit access to contents of the server by clients. If a server is down, unavailable, or unable to handle network traffic, then data and applications at the server are unreachable by a client. Thus, there is a need for an improved method of accessing information from a server by a client. Additionally, there is a need for improved transmission of data in a network from a server to a client. Furthermore, there is a need for faster access to information in a network. Therefore, there is a need for a dynamic distribution and network storage system.

### BRIEF SUMMARY OF THE INVENTION

According to certain aspects of an embodiment of the present invention, a system for dynamic distribution and network storage of data includes a network for transmitting data. The network is capable of transmitting the data from a first connection to a second connection and is further capable of circulating the data within the network in order to store the data. The system may also include a server for transmitting the data to the network, a client for requesting the data from the network, and a network manager for monitoring the network. The system may also include a staging server for selecting the data to be circulated and stored within the network. The staging server may modify the data to indicate that the data is to be circulated and stored within the network. The network may also include at least one router for transmitting the data. The router(s) are preferably capable of transmitting the data from a first connection to a second connection and also circulating the data within the network in order to store the data. The network may also include at least one edge router for receiving updates to the data stored on the network. The data may, for example, be a web page, an application, a database, or other data.

According to certain aspects of an embodiment of the present invention, a method for dynamic distribution and network storage of data includes transmitting data to a network and circulating the data within the network in order to store the data. The method also includes determining which data is to be circulated and stored within the network. The data may be divided into packets, and the packets may be modified to indicate that the packets should be circulated within the network in order to store the data. The data may be transmitted from the network to a client, in which case the data may be transmitted to the client and copied for circulation on the network. Additionally, the status of the network and network data may be monitored.

### BRIEF DESCRIPTION OF SEVERAL VIEWS OF THE DRAWINGS

FIG. 1 illustrates a prior art client/server network.

FIG. 2 illustrates a dynamic distribution and network storage system in accordance with certain aspects of an embodiment of the present invention.

FIG. 3 shows the fields present in an IP header and a TCP header of a data packet.

FIG. 4 illustrates a dynamic distribution and network storage system in accordance with certain aspects of an embodiment of the present invention.

FIG. 5 illustrates a flow diagram for storing and retrieving data on a network in accordance with certain aspects of an embodiment of the present invention.

### DETAILED DESCRIPTION OF THE INVENTION

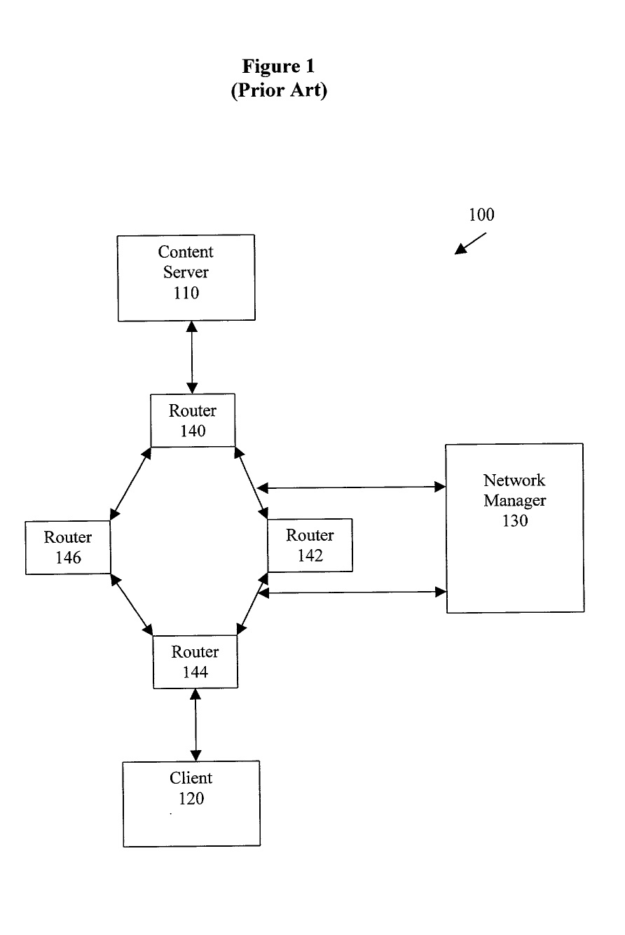

FIG. 1 illustrates a client/server network 100, as found in the prior art. Typically, the client 120 makes a request to the content server 110 via the network of routers 140, 142, 144, 146. The routers 140, 142, 144, 146 relay the request to the content server 110. The content server 110 then produces the requested data, for example, and transmits the requested data back to the client 120 via the network of routers 140, 142, 144, 146. The network manager 130 monitors and manages the network of routers 140, 142, 144, 146. Each time the client 120 requests the data or application, for example, the requested data or application is again retrieved from the content server 110 and transmitted to the client 120 via the network of routers 140, 142, 144, 146.

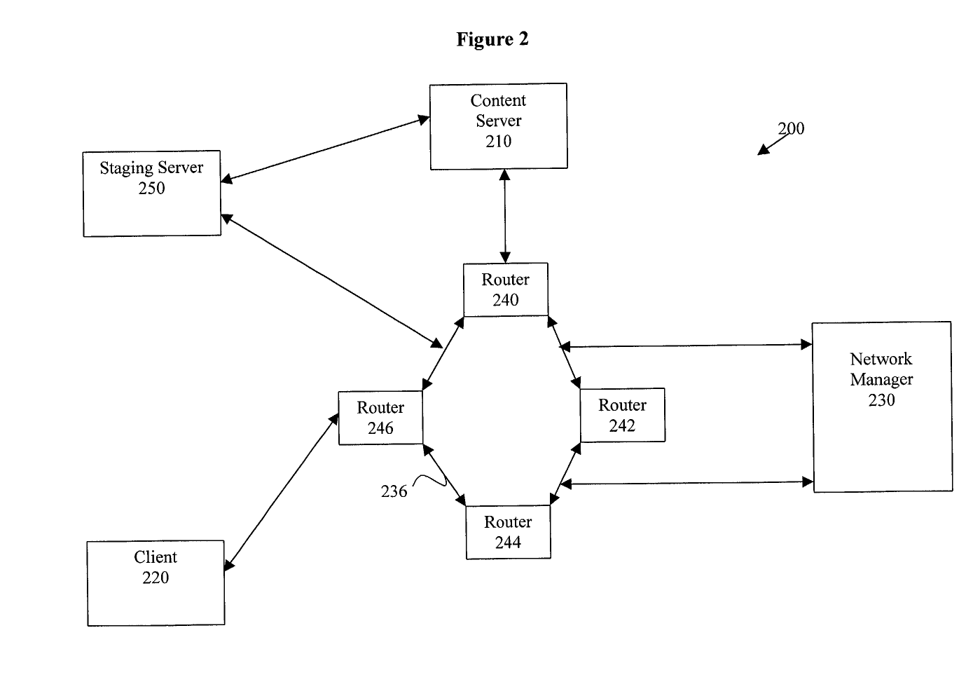

FIG. 2 illustrates a dynamic distribution and network storage system 200 in accordance with certain aspects of an embodiment of the present invention. The system 200 is described in the context of an Internet application. However, it will be appreciated that the system 200 has application in any network, such as a local area network, a wide area network, a private network, or other network, where it is desirable to store selected data directly on a network as opposed to a server. The system 200 includes a content server 210, a client 220, a network manager 230, a network 236 of routers 240, 242, 244, 246, and a staging server 250. For illustration purposes and for clarity, the system 200 has been shown with one content server 210, one staging server 250, one client 220, one network manager 230, and four routers 240, 242, 244, 246. It will be appreciated, however, that the number of such devices may, and typically will, be far greater than what has been shown in FIG. 2.

The content server 210 is connected to the router 240 via a suitable connection such as an Ethernet connection, an ATM (Asynchronous Transfer Mode) connection, a wireless connection, a cable connection, or a fiber optic connection. As is shown, the server is connected to the network 236 through one of the routers 240. The content server 210 is also similarly connected to the staging server 250 via a suitable connection such as an Ethernet connection, an ATM connection, a wireless connection, a cable connection, or a fiber optic connection. The staging server 250 is also connected to at least one of the network 236 of routers 240, 242, 244, 246 via a suitable connection such as an Ethernet connection, an ATM connection, a wireless connection, a cable connection, or a fiber optic connection.

The client 220 may connect to the network 236 of routers 240, 242, 244, 246 via a suitable connection such as an Ethernet connection, an ATM connection, a wireless connection, a cable connection, or a fiber optic connection. The client 220 uses the network 236 of routers 240, 242, 244, 246 to access data on the content server 210.

The routers 240, 242, 244, 246 in the network 236 are interconnected with each other via connections such as an Ethernet connection, an ATM connection, a wireless connection, a cable connection, or a fiber optic connection (such as an OC-48 cable), for example. The network manager 230 is connected to the network 236 of routers 240, 242, 244, 246 via a connection such as an Ethernet connection, an ATM connection, a wireless connection, a cable connection, or a fiber optic connection.

The client 220 may be embodied in a number of devices such as a personal computer, a workstation, a mainframe, a browser, a terminal, a personal digital assistant, or a handheld computer, for example. The client 220 may, for example, include a web browser for viewing web pages, a processor for executing applications, and/or an application for viewing a database. In operation, a user may use the client 220 to request a web page, application, a database, or other data from the content server 210. Alternatively and/or additionally, the client 220 may be programmed to request a web page, an application, a database, or other data from the content server 210. The system 200 may contain more than one client 220, but, for the purposes of this example, one client 220 will be used.

The content server 210, the staging server 250, and the network manager 230 may be separate units. Alternatively, the content server 210, the staging server 250, and/or the network manager 230 may be integrated into a single unit or reside on one computer, for example. The content server 210, the staging server 250, and the network manager 230 may be a part of an Internet Service Provider (ISP). Additionally, at least part of the network of routers 240, 242, 244, 246 may be part of the ISP. The client 220 may access the ISP to retrieve data. The content server 210, the staging server 250, and the network manager 230 may be embodied in any of a number of devices, such as a personal computer, a workstation, a mainframe, a browser, a terminal, a personal digital assistant, or a handheld computer.

The content server 210 stores data such as web pages for viewing, applications for execution, and/or databases for retrieval and/or viewing. The content server 210 is adapted to supply a web page, an application, a database, or other data to the client 220 and to the routers 240, 242, 244, 246 upon request.

The staging server 250 includes a processor and software to convert data packets from the content server 210 into dynamic distribution and network storage packets (“DDNS packets”). The DDNS packets include additional information in the header indicating that the DDNS packet should be retained and circulated in the network 236 of routers 240, 242, 244, 246 after the packets have been transmitted to the client 220. In this respect, the staging server 250 may operate to modify an unused field in the TCP header, IP header, or other such header, for example, of each data packet to indicate that the packet is special and should be “stored” on the network 236 of routers 240, 242, 244, 246. Alternatively, the staging server 250 may add an additional field to the packet header to indicate that the packet is a DDNS packet. The staging server 250 may operate to create the DDNS data packets upon user request. The staging server 250 may also be programmed to automatically generate DDNS data packets from packets sent by the content server 210 based on predetermined criteria, as is explained below.

The network manager 230 monitors traffic in the network 236 of routers 240, 242, 244, 246 to help ensure data integrity and help balance network load. The network manager 230 may communicate with the routers 240, 242, 244, 246, the content server 210, the staging server 250, and the client 220 using SNMP (Simple Network Management Protocol), for example. The network manager 230 includes a processor and software to facilitate the network manager's 230 monitoring and communication functions. In this respect, the network manager 230 may include HP OpenView software, available from Hewlett Packard. HP OpenView allows centralized system administration of networks and distributed systems, monitors network events and actions, and also analyzes network performance and identifies bottlenecks and sources of network problems.

The network manager 230 may operate to monitor transfer speed, congestion, and packet loss, for example, in the network 236 of routers 240, 242, 244, 246. The network manager 230 may also detect whether packets have been lost or “dropped” in the network 236 of routers 240, 242, 244, 246 and whether packets should be regenerated at the content server 210, for example. Additionally, the network manager 230 may instruct the staging server 250 to recreate DDNS packets or generate new DDNS packets for a new file, for example.

The routers 240, 242, 244, 246 may be embodied in any suitable network router, such as Cisco routers, for example. The routers 240, 242, 244, 246 transmit information between the content server 210 and the client 220. The network 236 of routers 240, 242, 244, 246 may also communicate with the network manager 230 and/or the staging server 250. Preferably, the routers 240, 242, 244, 246 include hardware and software to route data packets to their destination. The routers 240, 242, 244, 246 also include a table or database that tracks information such as which packets are currently in the router, which packets have been routed, where packets have been routed, which packets are next, and which packets are DDNS packets, for example.

Each router 240, 242, 244, 246 preferably includes at least two data transfer points. That is, the routers 240, 242, 244, 246 may transmit and/or receive data via at least two data connections or communications interfaces. The routers 240, 242, 244, 246 may be programmed with the structure of the network 236 connected to the data transfer points. For example, the network manager 230 may program the routers 240, 242, 244, 246 with the structure of the network 236. The routers 240, 242, 244, 246 may also automatically detect the devices connected to the data transfer points. For example, the router 242 may detect that it is connected to the router 240 and the router 244. Thus, the router 242 may transfer data to the router 240 or the router 244.

In operation, the client 220 generates a request for a web page, an application, a database, or other data, for example. For purposes of illustration only, system operation will be described in terms of a request for a web page by a web browser running on the client 220. After the request has been generated, the request is transmitted from the client 220 to the router 246 in the form of at least one data packet. The router 246 examines the header information of the packet to determine packet identity and destination and relays the packet to the router 240. Then, the router 240 examines the packet header and forwards the packet to the content server 210.

Once the content server 210 receives the request from the client 220 via the router 240, the content server 210 retrieves the requested web page file from memory. The content server 210 divides the hypertext markup language (“html”) file that represents the web page into packets of data for transmission to the client 220. The content server 210 then communicates with the staging server 250. The staging server 250 determines if the web page satisfies predetermined criteria, such as frequency of request, size of file, amount of graphics, or other selection criteria, for example. If the staging server 250 determines that the web page satisfies the criteria (the web page is being accessed over a pre-determined threshold in frequency, for example), then the staging server 250 converts the web page file packets into DDNS packets. Determination of special DDNS status at the staging server 250 may be automatic via software or may be manually triggered by an operator, for example.

A packet is converted to a DDNS packet by writing a DDNS flag or special DDNS packet information in the packet header. The flag or special information may be written in an unused header field, such as the “options” field of the TCP header, for example. The options field of the IP header or other such header may be used as well. Alternatively, an additional field may be created in the header in which to write DDNS packet information or DDNS packet flag.

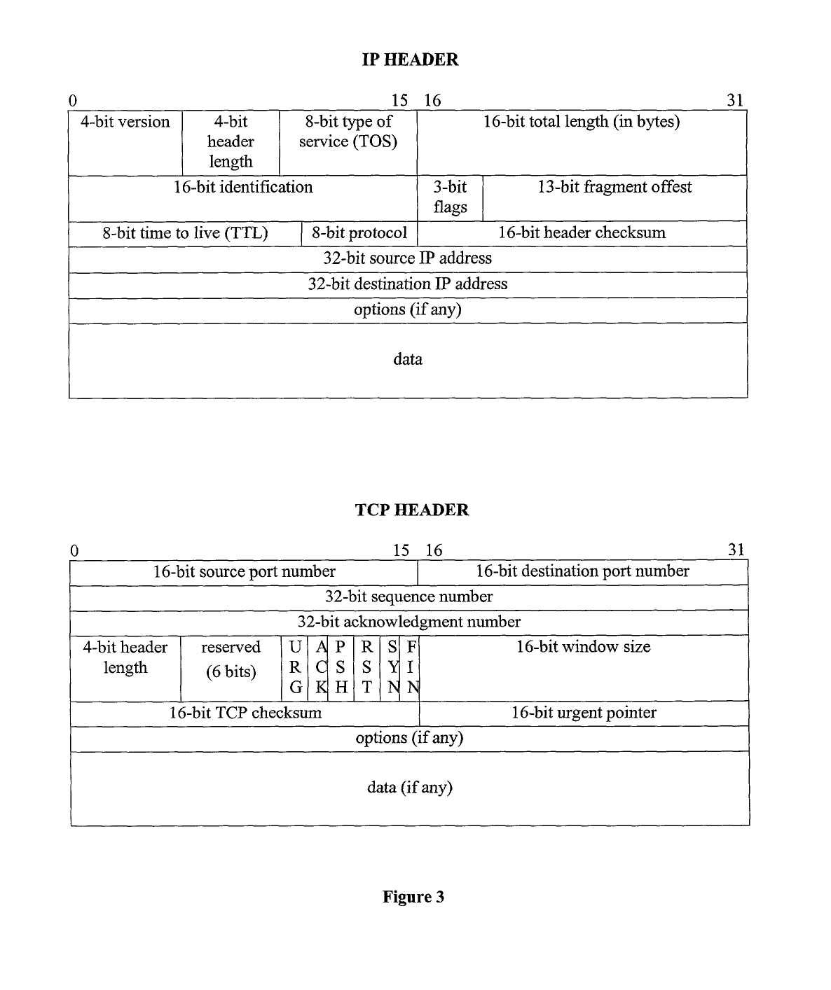

FIG. 3 shows the fields present in an IP header and a TCP header of a data packet. As described above, the “options” field of the TCP header or the IP header may be modified to indicate the DDNS nature of the data packet. Alternatively, an additional field may be added to one of the packet headers, such as the IP header or the TCP header, for example. The routers 240, 242, 244, 246 and the network manager 230 may be programmed to read the DDNS field (whether it is the options field or a new field, for example) and to recognize the DDNS packets.

Once the packets have been converted into DDNS packets by the staging server 250, the content server 210 sends the converted packets to the router 240. The staging server 250 may also send the converted packets to the router 240. The router 240 then examines the packet headers for data packet identity and destination information, for example, and forwards the incoming packets to the router 246. Next, the router 246 examines the incoming packet headers and forwards the packets to the client 220 for viewing on the client's 220 web browser.

In addition, the router 246 inspects the packet headers to determine if the packets are DDNS packets. That is, the router 246 examines the packet header to determine if the DDNS flag or other special DDNS information has been inserted in the options field or other field, for example. If the packets are DDNS packets, then the router 246 copies the forwarded packets. Then, the router 246 forwards the copied packets to the router 244, which may forward the packets to the router 242. Thus, the packets circulate through the network 236 of routers 240, 242, 244, 246. That is, the network 236 of routers 240, 242, 244, 246 serves as storage for the web page, application, database, or other file. The network 236 of routers 240, 242, 244, 246 thus becomes a dynamic distribution and network storage system.

The DDNS packets are forwarded among the network 236 of routers 240, 242, 244, 246 so that the DDNS packets may be subsequently requested again by the client 220 or another client. By forwarding the DDNS packets among the network 236 of routers 240, 242, 244, 246 and, thus, storing the DDNS packets in the network 236 of routers 240, 242, 244, 246, access to data contained in the DDNS packets may be improved. Additionally, the content server 210 workload may be decreased. Also, the bottleneck that may occur in the connection between the content server 210 and the network 236 of routers 240, 242, 244, 246 may be eliminated in favor of the bandwidth available in the network 236 of routers 240, 242, 244, 246.

Each router 240, 242, 244, 246 maintains a table that lists which packets are currently residing on the network 236 of routers 240, 242, 244, 246. Additionally, the network manager 230 monitors the network 236 of routers 240, 242, 244, 246. The network manager 230 uses a protocol, such as SNMP, for example, to communicate with the routers 240, 242, 244, 246 to determine the status of the routers 240, 242, 244, 246, the status of data on the routers 240, 242, 244, 246, and/or transmit instructions to the routers 240, 242, 244, 246, for example. The network manager 230 also communicates with the staging server 250.

The staging server 250 may instruct the network 236 of routers 240, 242, 244, 246 and/or the network manager 230 which packets are DDNS packets and which packets belong together. Alternatively, the network manager 230 may inform the routers 240, 242, 244, 246 which packets are DDNS packets and which packets are in sequence. The network manager 230 monitors traffic on the network of routers 240, 242, 244. 246 and facilitates re-routing of data if a router 240, 242, 244, 246 is down or overloaded, for example. Additionally, when data loss occurs, the network manager 230 may instruct the content server 210 and/or the content server 210 to recreate the lost or damaged packet(s).

As described above, the network manager 230 monitors activity and requests on the network 236 of routers 240, 242, 244, 246. By examining network requests and activity, the network manager 230 may automatically determine what data is to be stored on the network 236 at any given time. Based on such examination, the network manager 230 may, for example, instruct the network 236 of routers 240, 242, 244, 246 to stop circulating a first set of DDNS packets. Additionally, the network manager 230 may instruct the staging server 250 to create a second set of DDNS packets to be circulated on the network 236 of routers 240, 242, 244, 246 in place of or in addition to the first set of DDNS packets. Alternatively, the network manager 230 may transmit information to the staging server 250 so that a human operator may evaluate the information to determine whether certain packets should be made DDNS packets. The network manager 230 may instruct the network 236 of routers 240, 242, 244, 246 to forward and “store” the second set of DDNS packets in the network 236 of routers 240, 242, 244, 246 as described above.

Alternatively, the staging server 250 may monitor activity and requests on the network 236 of routers 240, 242, 244, 246 and may generate a second set of DDNS data packets. The staging server 250 may also then inform the network manager 230 and the network 236 of routers 240, 242, 244, 246 of the existence of the second set of DDNS packets.

Thus, the system 200 provides a method for storing a file, such as a frequently requested web page, application, database, or other data, for example, on the network 236 of routers 240, 242, 244, 246, rather than repeated retrieval of the file from the content server 210. After an initial retrieval from the content server 210, the client 220 (or any other client) may retrieve the file from the network 236 of routers 240, 242, 244, 246 without accessing the server. The network manager 230 may determine that the file requested by the client 220 is present on the network 236 of routers 240, 242, 244, 246. If the file is present on the network 236 of routers 240, 242, 244, 246 in the form of DDNS packets, the DDNS packets may be routed to the client 220 directly from the network 236, as opposed to being retrieved and routed from the content server 210.

The system 200 is constructed so that existing security systems or security software function properly. For example, data packets may be encrypted by the content server 210 or staging server 250 and unencrypted by the client 220. Additionally, a user authentication system may refer back to the content server 210 to verify that a user is allowed to access data. Alternatively, a user authentication scheme may reside on the network 236 of routers 240, 242, 244, 246 and may be executed on the network 236 of routers 240, 242, 244, 246 or at the client 220, for example.

The system 200 may be configured such that the details of system 200 operation and DDNS packet handling may be hidden from the client 220 to provide transparency of data retrieval on the client 220 end. In order to hide the information, the router 240 may remove the DDNS information from packet headers of the packets forwarded to the client 220, while retaining all header information in the packets copied and forwarded to the router 242.

The content server 210 may include an application or a web page containing an application, for example. Additionally, an application within a web page may refer to data that is changing on the content server 210. The network manager 230 may instruct the network 236 of routers 240, 242, 244, 246 to check the content server 210 for updates when an application on the network 236 of routers 240, 242, 244, 246 is requested by the client 220. Additionally, execution of an application may occur at the content server 210. For example, if a web page “stored” on the network 236 of routers 240, 242, 244, 246 contains an application, when the web page is requested by the client 220, the network 236 of routers 240, 242, 244, 246 may transmit the web page to the client 220. Then, the content server 210 may execute the application in the web page, and the network 236 of routers 240, 242, 244, 246 may transmit the results to the client 220. In one embodiment, an application may be stored and executed on the network 236 of routers 240, 242, 244, 246. In another embodiment, an application may be stored on the network 236 of routers 240, 242, 244, 246 and executed at the client 220.

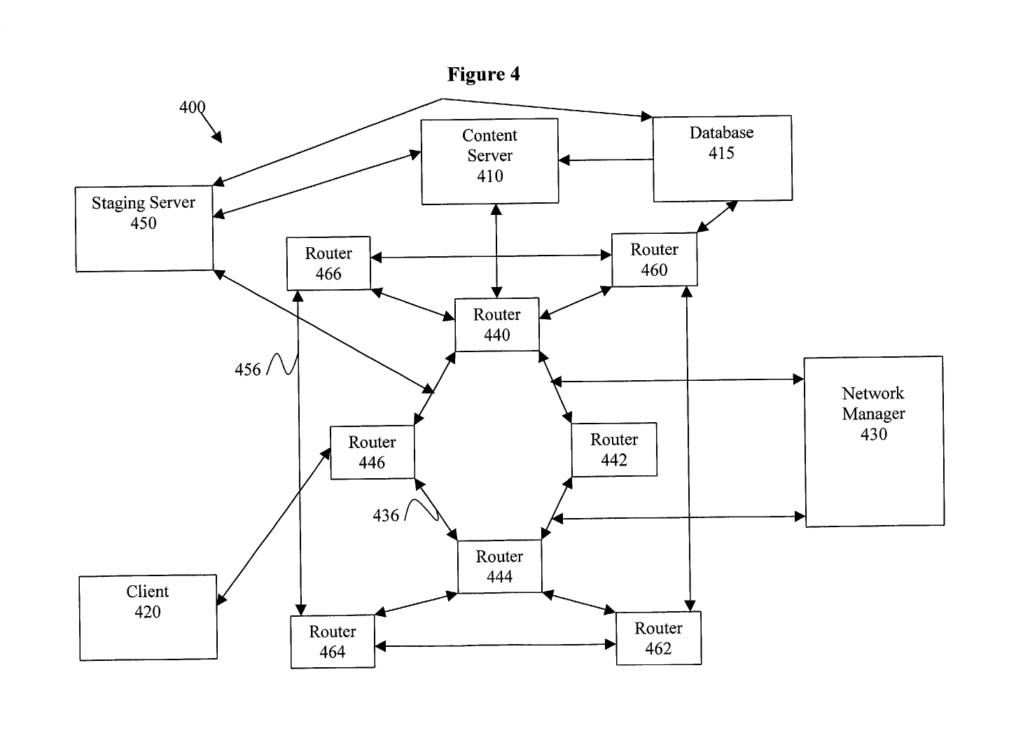

FIG. 4 illustrates a dynamic distribution and network storage system 400 in accordance with certain aspects of an embodiment of the present invention. The system 400 includes a content server 410, a database 415, a client 420, a network manager 430, a network 436 of core routers 440, 442, 444, 446, a staging server 450, and a network 456 of edge routers 460, 462, 464, 466. The system 400 is similar to the system 200 described above, with the addition of the database 415 and the network 456 of edge routers 460, 462, 464, 466.

Information is requested and transmitted between the client and the content server 410 as described above in reference to FIG. 2, with the following differences. The system 400 includes the network 456 of edge routers 460, 462, 464, 466 in addition to the network 436 of core routers 440, 442, 444, 446. The network 456 of edge routers 460, 462, 464, 466 is located outside the core routers 440, 442, 444, 446. The system 400 also includes a database 415 whose contents may change dynamically. The database 415 may communicate with the staging server 450 and the network 456 of edge routers 460, 462, 464, 466. The network 456 of edge routers 460, 462, 464, 466 may also communicate with the network 436 of core routers 440, 442, 444, 446. Preferably, the network 456 of edge routers 460, 462, 464, 466 communicates with the database 415, and the database 415 may be continuously available on the network 456 of edge routers 460, 462, 464, 466. If the client 420 requests information from the database 415, the network 436 of core routers 440, 442, 444, 446 may communicate with the network 456 of edge routers 460, 462, 464, 466 to retrieve the database information from the network 456 of edge routers 460, 462, 464, 466.

The database 415 may be separated from the content server 410. Alternatively, the database 415 may be located at the content server 410. As described above in reference to FIG. 2, the database 415, the content server 410, the network manager 430, and/or the staging server 450 may be integrated into a single unit or reside on one computer. Additionally, the database 415, the content server 410, the network manager 430, and/or the staging server 450 may be part of an ISP.

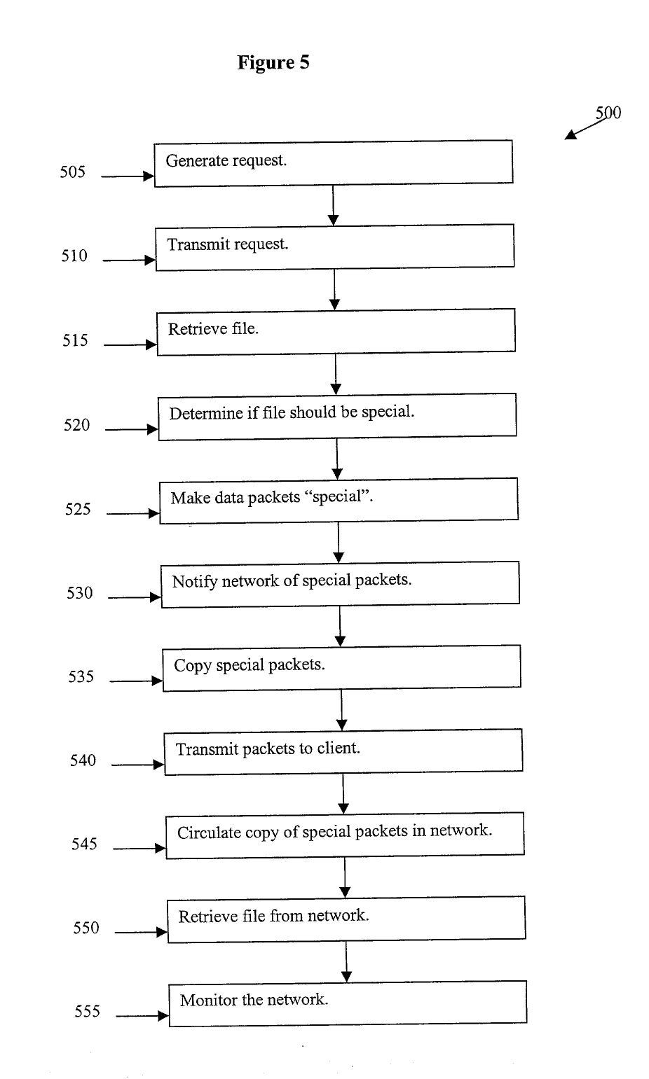

FIG. 5 illustrates a flow diagram 500 for storing and retrieving data on a network in accordance with a preferred embodiment of the present invention. First, at step 505, a client, such as a personal computer, a terminal, a personal digital assistant, a handheld computer, a web browser, or other access device, for example, requests a file, such as a web page, an application, a database, or other data, for example. For example, a user with a web browser on a personal computer attempts to view a web page on a web server. Next, at step 510, the request is transmitted to a content server via a network of routers, for example. For example, the request is transmitted from the personal computer to at least one router that forwards the request to the web server. Then, at step 515, the content server retrieves the requested file. For example, the web server loads the requested web page.

At step 520, a determination is made as to whether the requested file should be modified as a dynamic distribution and network storage (DDNS) file. Marking the file as a DDNS file indicates that the file may be circulated or “stored’ on the network of routers. Preferably, a file is made a DDNS file if a predetermined criterion is satisfied. Criteria may include the number of times the file has been accessed within a certain period, the frequency of access to a file compared to the frequency of access to other files, file size, or any other desired selection criterion. For example, the requested web page accounts for 50% of all the web pages accessed within a certain period of time at the web server. Thus, the requested web page is a candidate for storage on the network and should be converted to a “special” DDNS file.

If a file is to be made a DDNS file, then, at step 525, data packets of the file are modified to include an indication or notification that the packets of the file are to be “stored” on the network of routers. An indication may be inserted in the “options” field or other field of each packet header in the file, for example. For example, a flag indicating that the packet is a DDNS packet and should be circulated by the routers is written into the options field of the TCP header of each data packet for the web page. Next, at step 530, the network is notified of the DDNS packets. Thus, the components of the network know to circulate the DDNS packets and, thus, “store” them on the network. For example, the network manager is notified of the DDNS packets that form the requested web page. The network manager adds the DDNS packets to its routing table so that the network manager may instruct the network of routers to continue forwarding the DDNS packets from one router to the next router.

Then, at step 535, the DDNS packets are copied by a router on the network. At step 540, one set of the DDNS packets is transmitted to the client for viewing at the client. For example, the router that is to transmit the web page packets to the web browsing computer keeps a copy of the DDNS packets in addition to forwarding the DDNS packets to the computer. The DDNS information in the packet header may be stripped from the packet header before the DDNS packet is transmitted to the client in order to keep routing and storage operation transparent to the end user.

Additionally, at step 545, the copied set of the DDNS packets is circulated from one router to the next router in the network. That is, a copy of the DDNS packets representing the requested file is stored on the network in addition to the packets being transmitted to the client for viewing or other use. Thus, for example, the web browser receives the data and may display the web page, while the router may forward and “store” the DDNS web page packets in the network of routers. Storage on the network may alleviate stress on the content server and may improve file access and network stability. Then, at step 550, if the same file is again requested (e.g., by the same or another client), the DDNS packets of the file may be retrieved from the network rather than from the content server. For example, if another user views the same web page, the web page is retrieved from the network of routers rather than from the web server. By retrieving the file from the network rather than from the content server, the work load on the content server may be reduced, system crashes may be reduced, and the speed and bandwidth of the network may be utilized.

At step 555, a network manager or other network monitoring device may monitor the network. The network manager may monitor the network to determine whether a set of DDNS packets still meets the predetermined criteria discussed above. If the set of DDNS packets does not meet the criteria, the network manager may instruct the network to discard the set of DDNS packets. Additionally, the network manager may replace a first set of DDNS packets for a first file with a second set of DDNS packets for a second file. For example, the web page may no longer be accessed frequently, and a second web page may now be frequently accessed at the web server. Then the packets of the first web page may be discarded, and the packets of the second web page may be converted to DDNS packets and may be stored on the network of routers. Preferably, the network of routers may store multiple packets representing multiple files.

The network manager may also monitor the content server to determine if the contents of a file have changed. If the contents of a file that is on the network have been changed, then the DDNS packets of the file may be re-generated. The re-generated DDNS packets may be circulated on the network in place of the outdated packets.

The network and/or the client may also refer back to the content server for an application and/or a database, for example, in addition to retrieving a requested file from the network. That is, a web browser may request a web page that also includes an application. The web page may be transmitted to the web browser from the network. When a user at the web browser seeks to execute the application in the web page, the web browser may communicate with the content server to execute the application. The results of the application execution may be transmitted to the web browser via the network. Furthermore, if a database exists on the network, an edge network of routers may receive updates as contents of the database change, and the edge network may communicate the data to a core network of routers when the database data is requested.

Thus, certain aspects of an embodiment of the present invention provide a method and system for improving access to data from a server by a client through direct retrieval from the network rather than from the server itself. Certain aspects of an embodiment provide for improved transmission of data in a network from a server to a client by eliminating delays inherent in communication between a server and a network. Additionally, certain aspects of an embodiment may reduce server downtime or unavailability due to high traffic volume. The network manager may also distribute network traffic among routers to account for an overloaded or unavailable router.

Certain aspects of an embodiment of the present invention may improve transmission and access through the storage capacity and speed of the network of routers and cables. The dynamic distribution and network storage system may improve system reliability and efficiency of access to data by clients by distributing resources and eliminating bottlenecks.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A dynamic distribution and network storage system, said system comprising:
a network for transmitting data, said network capable of transmitting said data from a first connection to a second connection, said network further capable of circulating said data within said network in order to store said data.

2. The system of claim 1, further comprising a server for transmitting said data to said network.

3. The system of claim 1, further comprising a client for requesting said data from said network.

4. The system of claim 1, further comprising a staging server for selecting data to be circulated within said network in order to store said data.

5. The system of claim 1, wherein said staging server modifies said data to indicate that said data is to be circulated within said network in order to store said data.

6. The system of claim 1, further comprising a network manager for monitoring said network.

7. The system of claim 1, wherein said network further includes at least one router for transmitting said data, said at least one router capable of transmitting said data from a first connection to a second connection, said at least one router further capable of circulating said data within said network in order to store said data.

8. The system of claim 7, wherein said network further includes at least one edge router for receiving updates for said data.

9. The system of claim 1, wherein said data comprises at least one of a web page, an application, and a database.

10. A method for storing data on a network, said method comprising:
transmitting data to a network; and
circulating said data within said network in order to store said data.

11. The method of claim 10, further comprising determining which data is to be circulated within said network in order to store said data.

12. The method of claim 10, further comprising dividing said data into packets.

13. The method of claim 12, further comprising modifying said packets to indicate that said packets should be circulated within said network in order to store said data.

14. The method of claim 10, further comprising monitoring status of said network.

15. The method of claim 10, further comprising transmitting said data to a client.

16. The method of claim 15, further comprising copying said data for circulation on said network.

17. A method for information retrieval, said method comprising:
requesting data from a network, said network storing said data by circulating said data within said network;
transmitting said data from said network to a client.

18. The method of claim 17, further comprising determining if said data requested is present on said network.

19. The method of claim 17, further comprising copying said data for circulation on said network.

20. The method of claim 17, further comprising modifying said data before transmitting said data from said network to said client.

21. A system for network storage of data, said system comprising:
a server, said server including data;
a client for requesting data;
a network of routers, said network of routers transmitting said data from said server to said client, said network of routers further storing a copy of said data on said network of routers;
a staging server for determining data to be stored on said network of routers; and
a network manager monitoring said network of routers.

22. A system for distributing and storing data, comprising:
a router adapted to store data;
at least one client adapted to request data; and
a router network adapted to transmit data between the router and the client, the router network further being adapted to selectively store copies of said transmitted data and to subsequently transmit said stored data to a client in response to a data request.

23. A data server, said server including at least one file, said server capable of dividing said at least one file into data packets, said server adapted to modify said data packets to create dynamic distribution and network storage packets from said data packets, said dynamic distribution and network storage packets including information indicating that said dynamic distribution and network storage packets may be stored on a network, said server further capable of transmitting said dynamic distribution and network storage packets to a network for storage.

24. The data server of claim 23, wherein said information comprises a flag in said dynamic distribution and network packet header indicating that said dynamic distribution and network storage packet is to be stored on said network.

25. A data packet for storage on a network of routers, said data packet comprising:
data to be transmitted and stored; and
header information, said header information including a flag indicating that said data packet is to be stored on said network of routers.
